(19) United States
(12) Patent Application Publication
(10) Pub. No.: US 2026/0230958 A1
(43) Pub. Date: Aug. 6, 2026

(54) DEVICES AND METHODS OF COMMUNICATION

(71) Applicant: NEC Corporation, Tokyo (JP)

(72) Inventors: Da WANG, Beijing (CN); Lin LIANG, Beijing (CN); Gang WANG, Beijing (CN)

(73) Assignee: NEC Corporation, Tokyo (JP)

(21) Appl. No.: 19/149,202

(22) PCT Filed: Jan. 19, 2023
(86) PCT No.: PCT/CN2023/073183

§ 371 Date: Jul. 18, 2025

(51) Int. Cl. H04W 36/00; H04L 1/1812; H04W 36/08

(52) U.S. Cl. CPC H04W 36/00725; H04L 1/1812; H04W 36/08

(57) ABSTRACT

Embodiments of the present disclosure relate to devices and methods of communication. In one aspect, a terminal device receives, from a network device, a configuration for security of a MAC layer. If a MAC CE is to be received, the terminal device performs, based on the configuration, at least one of deciphering or integrity verification on the MAC CE. In this way, MAC layer security may be ensured.

### TECHNICAL FIELD

Embodiments of the present disclosure generally relate to the field of telecommunication, and in particular, to devices and methods of communication for layer 1 (L1)/layer 2 (L2) triggered mobility (LTM).

### BACKGROUND

When user equipment (UE) moves from a coverage area of one cell to that of another cell, a change or addition or release of a serving cell may need to be performed. Currently, it has been proposed to trigger the change or addition or release of the serving cell by a lower-layer signaling such as L1/L2 signaling, which is also referred to as LTM. In this way, latency, overhead and interruption time may be reduced. However, solutions for LTM are still incomplete and needs to be further developed.

### SUMMARY

In general, embodiments of the present disclosure provide methods, devices and computer storage media of communication for LTM.

In a first aspect, there is provided a terminal device. The terminal device comprises a processor. The processor is configured to cause the terminal device to: receive, from a network device, a configuration for security of a medium access control (MAC) layer; and in accordance with a determination that a medium access control control element (MAC CE) is to be received, perform, based on the configuration, at least one of deciphering or integrity verification on the MAC CE.

In a second aspect, there is provided a terminal device. The terminal device comprises a processor. The processor is configured to cause the terminal device to: in accordance with a determination that a first MAC CE indicating a cell switch to a target candidate cell is received from a network device, start a timer for failure detection in the cell switch; determine that a random access procedure for the cell switch is skipped; and in accordance with a determination that an indication of completion of the cell switch is received from the network device, stop the timer.

In a third aspect, there is provided a terminal device. The terminal device comprises a processor. The processor is configured to cause the terminal device to: receive, from a network device, a MAC CE indicating a cell switch; and in accordance with a determination that a partial MAC reset procedure is performed, enable a periodic power headroom report (PHR).

In a fourth aspect, there is provided a terminal device. The terminal device comprises a processor. The processor is configured to cause the terminal device to: receive, from a network device, a MAC CE indicating a cell switch; and perform a service data unit (SDU) discard for a signal radio bearer (SRB) by a packet data convergence protocol (PDCP) entity of the network device.

In a fifth aspect, there is provided a method of communication. The method comprises: receiving, at a terminal device and from a network device, a configuration for security of a MAC layer; and in accordance with a determination that a MAC CE is to be received, performing, based on the configuration, at least one of deciphering or integrity verification on the MAC CE.

In a sixth aspect, there is provided a method of communication. The method comprises: in accordance with a determination that a first MAC CE indicating a cell switch to a target candidate cell is received from a network device, starting, at a terminal device, a timer for failure detection in the cell switch; determining that a random access procedure for the cell switch is skipped; and in accordance with a determination that an indication of completion of the cell switch is received from the network device, stopping the timer.

In a seventh aspect, there is provided a method of communication. The method comprises: receiving, at a terminal device and from a MAC CE indicating a cell switch; and in accordance with a determination that a partial MAC reset procedure is performed, enabling a PHR.

In an eighth aspect, there is provided a method of communication. The method comprises: receiving, at a terminal device and from a network device, a MAC CE indicating a cell switch; and performing a SDU discard for a SRB by a PDCP entity of the network device.

In a ninth aspect, there is provided a computer readable medium having instructions stored thereon. The instructions, when executed on at least one processor, cause the at least one processor to perform the method according to any of the fifth to eighth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram illustrating a process of LTM in which some embodiments of the present disclosure can be implemented;

FIG. 2 illustrates a schematic diagram illustrating a process of communication for security of LTM according to embodiments of the present disclosure;

FIG. 3 illustrates a schematic diagram illustrating example MAC CEs according to embodiments of the present disclosure;

FIG. 4 illustrates a schematic diagram illustrating another process of communication for random access channel (RACH)-less LTM according to embodiments of the present disclosure;

FIG. 5 illustrates a schematic diagram illustrating still another process of communication for power headroom report (PHR) according to embodiments of the present disclosure;

FIG. 6 illustrates a schematic diagram illustrating yet another process of communication for service data unit (SDU) discard for a signal radio bearer (SRB) according to embodiments of the present disclosure;

FIG. 7 illustrates an example method of communication implemented at a terminal device in accordance with some embodiments of the present disclosure;

FIG. 8 illustrates another example method of communication implemented at a terminal device in accordance with some embodiments of the present disclosure;

FIG. 9 illustrates still another example method of communication implemented at a terminal device in accordance with some embodiments of the present disclosure;

FIG. 10 illustrates yet another example method of communication implemented at a terminal device in accordance with some embodiments of the present disclosure; and

FIG. 11 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a cell switch” may be interchangeably used with “reconfiguration with sync for secondary cell group (SCG) or master cell group (MCG)” or “a cell change”. The term “PSCell” refers to a SpCell of a SCG the term “PCell” refers to a SpCell of a MCG, and the term “SpCell” refers to a primary cell of a SCG or MCG The term “SCell” refers to a secondary cell. The term “lower-layer signaling” may be interchangeably used with “L1/L2 signaling”. The term “RRC reconfiguration” may be interchangeably used with “RRC reconfiguration message”. The term “candidate cell” may be interchangeably used with “LTM candidate cell”. The term “target cell” may be interchangeably used with “target candidate cell”, “candidate target cell”, or “LTM target candidate cell”.

Embodiments of the present disclosure provide solutions of communication to further enhance solutions for LTM. In one aspect, a network device transmits, to a terminal device, a configuration for security of a MAC layer. If a MAC CE is to be received, the terminal device performs, based on the configuration, at least one of deciphering or integrity verification on the MAC CE. If a further MAC CE is to be transmitted, the terminal device performs, based on the configuration, at least one of ciphering or integrity protection on the further MAC CE. In this way, security for a MAC layer may be ensured.

In another aspect, a network device transmits, to a terminal device, a MAC CE indicating a cell switch. In response to the MAC CE, the terminal device starts a timer for failure detection in the cell switch. If the terminal device determines that a random access procedure is to be skipped for the cell switch, the terminal device stops the timer upon reception of an indication of completion of the cell switch from the network device. In this way, completion of RACH-less LTM may be indicated to a terminal device.

In still another aspect, a network device transmits, to a terminal device, a MAC CE indicating a cell switch. If the terminal device determines that a partial MAC reset procedure is to be performed, the terminal device enables a PHR. In this way, periodic PHR may be triggered in case of partial MAC reset during LTM.

In yet another aspect, when a terminal device receives, from a network device transmits, a MAC CE indicating a cell switch, the terminal device performs a SDU discard for a SRB by a PDCP entity of the terminal device. In this way, PDCP SDU discard for a SRB may be triggered during LTM without an RRC configuration for the PDCP SDU discard.

Principles and implementations of the present disclosure will be described in detail below with reference to the figures.

### Example of Communication Network

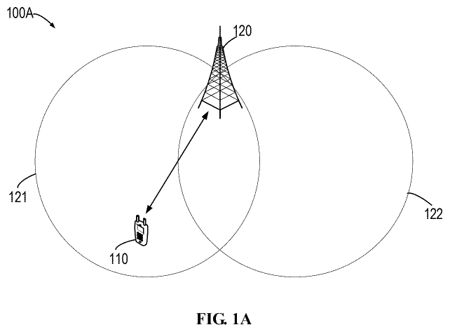

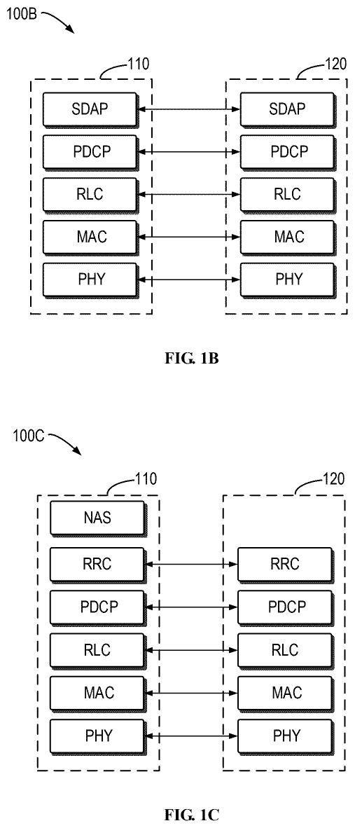

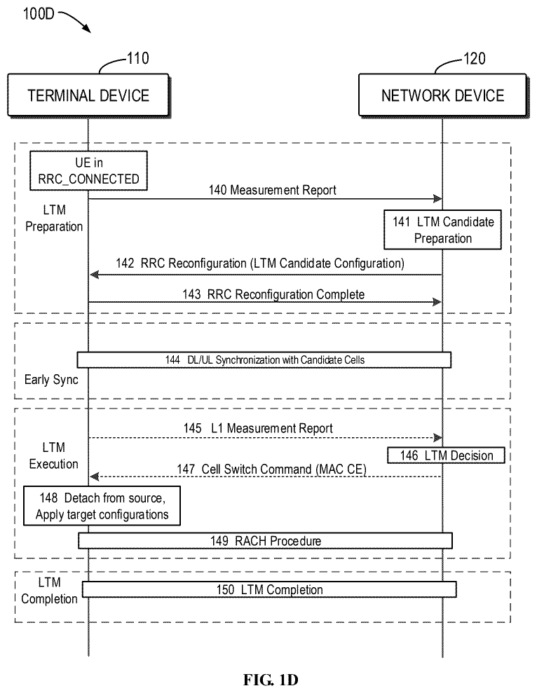

FIG. 1A illustrates a schematic diagram of an example communication network 100A in which some embodiments of the present disclosure can be implemented. As shown in FIG. 1A, the communication network 100A may include a terminal device 110 and a network device 120. The network device 120 provides a plurality of cells (cells 121 and 122 as shown) to serve a terminal device.

It is to be understood that the number of devices or cells in FIG. 1A is given for the purpose of illustration without suggesting any limitations to the present disclosure. The communication network 100A may include any suitable number of network devices and/or terminal devices and/or cells adapted for implementing implementations of the present disclosure.

As shown in FIG. 1A, the terminal device 110 may communicate with the network device 120 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 is referred to as uplink (UL) communication, while communication in a reverse direction from the network device 120 towards the terminal device 110 is referred to as downlink (DL) communication. The terminal device 110 can move amongst the cells of the network device 120 and possibly other network devices. In UL communication, the terminal device 110 may transmit UL data and control information to the network device 120 via a UL channel. In DL communication, the network device 120 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and layer 3 (L3) layers, or upper layers) including an entity for a medium access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a PDCCH, a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. Four types of SRBs may be defined in a RRC layer, i.e., SRB0, SRB1, SRB2 and SRB3. SRB0 uses a CCCH for RRC connection establishment or re-establishment. SRB1 uses a DCCH and is established when RRC connection is established. SRB2 uses a DCCH and is established during RRC reconfiguration and after initial security activation. SRB3 uses a DCCH and is established between the terminal device 110 and SN when a dual connection is established.

Return to FIG. 1A, in some embodiments, the terminal device 110 may be located within the coverage of cell 121 of the network device 120, and the terminal device 110 may communicate with the network device 120 based on network configuration. In this case, the cell 121 may be referred to as a serving cell of the terminal device 110. The cell 122 may be referred to as a LTM candidate cell of the terminal device 110.

In some embodiments, the terminal device 110 may establish a dual connection (i.e., simultaneous connection) with the network device 120 and another network device (not shown). In some embodiments, the network device 120 may serve as a master node (MN). In these embodiments, the terminal device 110 may communicate with the network device 120 via a set of serving cells. The set of serving cells form a MCG, and a primary cell in the MCG is called as PCell. In some scenarios, the PCell may be changed from the cell 121 to the cell 122. This is called as a handover (HO). In some embodiments, the network device 120 may serve as a secondary node (SN). In these embodiments, the set of serving cells provided by the network device 120 form a SCG, and a primary cell in the SCG is called as PSCell. In some scenarios, the PSCell may be changed from the cell 121 to the cell 122. This is called as a PScell change.

In some scenarios, the network device 120 may receive LI measurement reports from the terminal device 110. Based on the LI measurement reports, the network device 120 may change a serving cell of the terminal device 110 through a MAC CE. This procedure is called as LTM. The network device 120 may prepare one or multiple candidate cells and provides the candidate cell configurations to the terminal device 110 through a RRC message. Then LTM cell switch is triggered by selecting one of the candidate cell configurations as target configuration for LTM by the network device 120.

Cell switch trigger information may be conveyed in a MAC CE, which contains at least a candidate configuration index. Cell-specific, radio bearer, and measurement configurations may be part of an LTM candidate cell configuration. The terminal device 110 may perform contention based random access (CBRA) or contention free random access (CFRA) at a cell switch. The terminal device 110 may also skip a random access procedure if the terminal device 110 doesn't need to acquire timing advance (TA) for a target cell during the cell switch. RACH resources for CFRA may be provided in an RRC configuration.

FIG. 1D illustrates a schematic diagram illustrating a process 100D of LTM in which some embodiments of the present disclosure can be implemented. For the purpose of discussion, the process 100D will be described with reference to FIG. 1A. The process 100D may involve the terminal device 110 and the network device 120 as illustrated in FIG. 1A. The network device 120 may be a MN or SN serving the terminal device 110. In this example, the network device 120 provides a serving cell for the terminal device 110, and also provides one or more candidate cells for the terminal device 110.

As shown in FIG. 1D, at a LTM preparation stage, the terminal device 110 may send 140 a Measurement Report message to the network device 120. The network device 120 may decide 141 to use LTM and initiates LTM candidate preparation. The network device 120 may transmit 142 an RRCReconfiguration message to the terminal device 110 comprising the configuration of one or multiple LTM candidate target cells. The terminal device 110 may store the configuration of LTM candidate target cell(s) and transmit 143 a RRC Reconfiguration Complete message to the network device 120.

At an early synchronization (i.e., early sync) stage, the terminal device 110 may perform 144 DL synchronization and TA acquisition with candidate target cell(s) before receiving the LTM cell switch command.

At a LTM execution stage, the terminal device 110 may perform LI measurements on the configured LTM candidate target cell(s), and transmits 145 lower-layer measurement reports to the network device 120. The network device 120 may decide 146 to execute LTM cell switch to a target cell, and transmits 147 a MAC CE triggering LTM cell switch by including the candidate configuration index of the target cell. The terminal device 110 may switch 148 to the configuration of the LTM candidate target cell. The terminal device 110 may perform 149 a random access (RA) procedure towards the target cell, if TA is not available.

At a LTM completion stage, the terminal device 110 may indicate 150 successful completion of the LTM cell switch towards target cell.

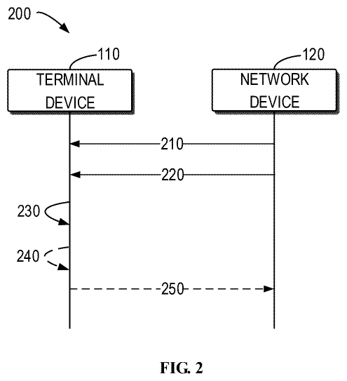

Embodiments of the present disclosure provide a solution of communication for LTM. Its detail will be described with reference to FIGS. 2 to 5.

### Example Implementation of Security Of MAC Layer

In conventional HO, RRC messages are used for HO commands and messages related to measurements, and encryption and integrity checks are performed to ensure security. For LTM, a cell switch command is sent by a MAC CE. However, security for a MAC layer is not supported yet, which would cause security risk for LTM procedure.

In view of this, embodiments of the present disclosure provide a solution of communication for security of a MAC layer. The solution will be described in connection with FIG. 2.

FIG. 2 illustrates a schematic diagram illustrating a process 200 of communication for security of LTM according to embodiments of the present disclosure. For the purpose of discussion, the process 200 will be described with reference to FIG. 1A. The process 200 may involve the terminal device 110 and the network device 120 as illustrated in FIG. 1A. In this example, the network device 120 provides a serving cell (e.g., the cell 121) for the terminal device 110 and also provides one or more candidate cells for the terminal device 110. The serving cell may be SPCell, PCell or PSCell of the terminal device 110.

As shown in FIG. 2, the network device 120 may transmit 210, to the terminal device 110, a configuration for security of a MAC layer.

In some embodiments, the configuration may comprise a configuration (for convenience, also referred to as a first configuration herein) for ciphering. In some embodiments, the first configuration may comprise a ciphering algorithm. In some embodiments, the first configuration may comprise an indication indicating whether the ciphering is enabled. For example, in case that a ciphering algorithm of a PDCP layer (i.e., the ciphering algorithm configured by securityConfig IE) is reused for a MAC layer, the first configuration may comprise an indication whether the ciphering is enabled or disabled. It is to be understood that the first configuration may comprise combination of the above information.

In some embodiments, the configuration may comprise a configuration (for convenience, also referred to as a second configuration herein) for integrity protection. In some embodiments, the second configuration may comprise an integrity protection algorithm. In some embodiments, the second configuration may comprise an indication indicating whether the integrity protection is enabled. For example, in case that an integrity protection algorithm of a PDCP layer (i.e., the integrity protection algorithm configured by securityConfig IE) is reused for a MAC layer, the second configuration may comprise an indication whether the integrity protection is enabled or disabled. It is to be understood that the second configuration may comprise combination of the above information.

It is also to be understood that the configuration for security of the MAC layer may comprise both the first and second configurations. That is, a security configuration of a MAC layer may comprise configurations for an integrity protection function and a ciphering function. Upon reception of the configuration for security of the MAC layer, the terminal device 120 may configure the ciphering function and integrity function of MAC entity with at least one of the ciphering algorithm, integrity protection algorithm, ciphering key or integrity protection key.

With reference to FIG. 2, in some embodiments, the network device 120 may transmit 220 a MAC CE to the terminal device 110. In some embodiments, the MAC CE may indicate LTM. In other words, the MAC CE may be used to trigger LTM cell switch. It is to be understood that any other suitable MAC CEs may also be feasible. In some embodiments, at least one of the integrity protection function or the ciphering function may be at least applied for the MAC CE.

In some embodiments, the MAC CE may comprise at least one of a sequence number of the MAC CE or a message authentication code for integrity (MAC-I). In some embodiments, the sequence number of the MAC CE may also be referred to as a count value of the MAC CE. It is to be understood that the MAC CE may also comprise content (i.e. the control filed) of the MAC CE. For MAC CE which triggers LTM cell switch, the content may include at least one of a candidate configuration index, a TCI state to be activated for the target candidate cell, or TA information for the target candidate cell.

Upon reception of the MAC CE from the network device 120, the terminal device 110 may perform 230 at least one of deciphering or integrity verification on the MAC CE.

In some embodiments, the terminal device 110 may perform the deciphering on the MAC CE. In some embodiments, the terminal device 110 may determine a set of input parameters comprising at least one of a sequence number (i.e., a count) of the MAC CE, a logic channel identity (LCID) of the MAC CE, a downlink (DL) direction, or a key for ciphering. The terminal device 110 may perform the deciphering on the MAC CE based on the set of input parameters. For example, the terminal device 110 may perform the deciphering on the MAC CE by inputting the set of input parameters to the ciphering algorithm.

In some embodiments, the key for ciphering may be a key defined for MAC layer ciphering. In some embodiments, the key for ciphering may be a key for user plane (UP) traffic, e.g., KUPenc. In some embodiments, the key for ciphering may be a key for RRC signaling, e.g., KRRCenc. It is to be understood that the key for ciphering may be defined in any other suitable ways.

In some embodiments, the terminal device 110 may perform the integrity verification on the MAC CE. In some embodiments, the terminal device 110 may determine a set of input parameters comprising at least one of a sequence number (i.e., a count) of the MAC CE, a LCID of the MAC CE, a DL direction, or a key for integrity protection. The terminal device 110 may perform the integrity verification on the MAC CE based on the set of input parameters. For example, the terminal device 110 may perform the integrity verification on the MAC CE by inputting the set of input parameters to the integrity protection algorithm.

In some embodiments, the key for integrity protection may be a key defined for MAC layer integrity protection. In some embodiments, the key for integrity protection may be a key for user plane (UP) traffic, e.g., KUPint. In some embodiments, the key for integrity protection may be a key for RRC signaling, e.g., KRRCint. It is to be understood that the key for integrity protection may be defined in any other suitable ways.

In some embodiments where both ciphering and integrity protection are performed on the MAC CE, the terminal device 110 may perform deciphering first, and then perform integrity verification. In some embodiments, data units that are deciphered may include a MAC-I and content of the MAC CE. In some embodiments, data units that are integrity verified may include content and a sequence number of the MAC CE before ciphering.

In some embodiments, if integrity verification fails, the MAC layer of the terminal device 110 may indicate the failure of integrity verification to an upper layer (e.g., an RRC layer) of the terminal device 110. In some embodiments, the MAC layer of the terminal device 110 may discard a MAC PDU which includes the MAC CE and consider the MAC PDU as being not received. In some embodiments, upon the RRC layer of the terminal device 110 receives an integrity verification failure indication from the lower layer (i.e. MAC layer), the RRC layer of the terminal device 110 may trigger an RRC connection re-establishment procedure.

In some embodiments, the terminal device 110 may expect to transmit a further MAC CE to the network device 120. In some embodiments, the MAC CE may indicate completion of a cell switch for LTM. It is to be understood that any other suitable MAC CEs may also be feasible. Continue to refer to FIG. 2, the terminal device 110 may perform 240 at least one of ciphering or integrity protection to generate the further MAC CE to be transmitted.

In some embodiments, the terminal device 110 may perform the ciphering for generation of the further MAC CE. In some embodiments, the terminal device 110 may determine a set of input parameters comprising at least one of a sequence number (i.e., a count) of the further MAC CE, a LCID of the further MAC CE, a UL direction, or the key for ciphering. The terminal device 110 may perform the ciphering based on the set of input parameters. For example, the terminal device 110 may perform the ciphering by inputting the set of input parameters to the ciphering algorithm.

In some embodiments, the terminal device 110 may perform the integrity protection for generation of the further MAC CE. In some embodiments, the terminal device 110 may determine a set of input parameters comprising at least one of a sequence number (i.e., a count) of the further MAC CE, a LCID of the MAC CE, a UL direction, or the key for integrity protection. The terminal device 110 may perform the integrity protection based on the set of input parameters. For example, the terminal device 110 may perform the integrity protection by inputting the set of input parameters to the integrity protection algorithm.

In some embodiments where both ciphering and integrity protection are to be performed to generate the further MAC CE, the terminal device 110 may perform integrity protection first, and then perform ciphering. In some embodiments, data units that are integrity protected may include a sequence number and content of the MAC CE. In some embodiments, data units that are ciphered may include content and MAC-I of the MAC CE before ciphering.

Upon generation of the further MAC CE, the terminal device 110 may transmit 250 the further MAC CE to the network device 120. In some embodiments, the further MAC CE may comprise at least one of a sequence number of the further MAC CE or a MAC-I. It is to be understood that the further MAC CE may also comprise content (i.e. the control filed) of the further MAC CE.

Embodiments of the present disclosure provide a design for a MAC CE which enables at least one of integrity protection and ciphering. The MAC CE may comprise content (i.e., a control field) and at least one of a sequence number of the MAC CE or a MAC-I.

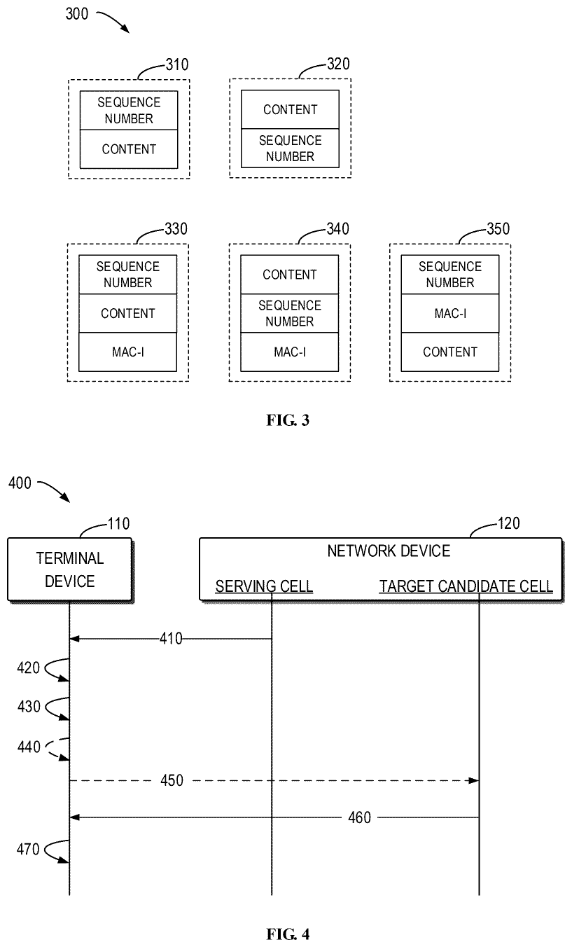

FIG. 3 illustrates a schematic diagram 300 illustrating example MAC CEs according to embodiments of the present disclosure. As shown in FIG. 3, in some embodiments, a MAC CE 310 may comprise a sequence number and content after the sequence number. In some embodiments, a MAC CE 320 may comprise content and a sequence number after the content. In some embodiments, a MAC CE 330 may comprise a sequence number, content after the sequence number and MAC-I after the content. In some embodiments, a MAC CE 340 may comprise content, a sequence number after the content and MAC-I after the sequence number. In some embodiments, a MAC CE 350 may comprise content, MAC-I after the content and a sequence number after the MAC-I.

In some embodiments for a MAC CE triggering LTM, content of the MAC CE may comprise at least one of the following: a candidate configuration index, a transmission configuration indication (TCI) state to be activated for a target cell, or TA information for the target cell.

So far, a solution for MAC layer security is described. In this way, a MAC CE transmitted between a terminal device and a network device may be safely transmitted.

### Example Implementation of RACH-Less LTM

Conventionally, for completion of LTM, a terminal device sends an indication to a target candidate cell, and the terminal device needs to receive a response from a network as an indication of the completion. However, if an RA procedure is skipped for LTM, the response from the network is unclear.

In view of this, embodiments of the present disclosure provide a solution of RACH-less LTM. The solution will be described below in connection with FIG. 4.

FIG. 4 illustrates a schematic diagram illustrating another process 400 of communication for RACH-less LTM according to embodiments of the present disclosure. For the purpose of discussion, the process 400 will be described with reference to FIG. 1A. The process 400 may involve the terminal device 110 and the network device 120 as illustrated in FIG. 1A. In this example, the network device 120 provides a serving cell (e.g., the cell 121) for the terminal device 110, and also provides a target candidate cell (e.g., the cell 122) for the terminal device 110. The serving cell may be SPCell, PCell or PSCell of the terminal device 110.

As shown in FIG. 4, the network device 120 (e.g., the serving cell) may transmit 410, to the terminal device 110, a MAC CE indicating a cell switch to a target candidate cell. In other words, the terminal device 110 may receive the MAC CE which triggers the cell switch to the target candidate cell.

Based on reception of the MAC CE, the terminal device 110 may start 420 a timer for failure detection in the cell switch. For example, an RRC layer or a MAC layer of the terminal device 110 may start a failure detection timer for LTM.

Continue to refer to FIG. 4, the terminal device 110 may determine 430 that an RA procedure for the cell switch is skipped. In some embodiments, if a TA value is provided in the MAC CE which triggers the cell switch, the terminal device 110 may decide to skip the RA procedure. In some embodiments, if a timer for time alignment is running for a timing advance group (TAG) to which the target candidate cell belongs, the terminal device 110 may determine to skip the RA procedure. It is to be understood that the skipping of the RA procedure may be determined based on a combination of the above information.

Continue to refer to FIG. 4, upon determination that the RA procedure is skipped, the terminal device 110 may start 440 performing PDCCH monitoring for a cell-radio network temporary identity (C-RNTI) on the target candidate cell. The terminal device 110 may transmit 450, to the network device 120 (e.g., the target candidate cell), an indication (for convenience, also referred to as a second indication herein) of completion of the cell switch towards the target candidate cell. The transmission 450 may be called as an initial transmission to a target candidate cell.

In some embodiments, the terminal device 110 may transmit the second indication by a UL grant configured in the first MAC CE. In some embodiments, the terminal device 110 may transmit the second indication by a UL grant configured in a configuration associated with the target candidate cell. In some embodiments, the terminal device 110 may transmit the second indication by a UL grant received from a PDCCH transmission of the target candidate cell addressed to an identity of the terminal device 110 (e.g., a UL grant received from target candidate cell's PDCCH for a MAC entity's C-RNTI). It is to be understood that the second indication may be transmitted by any combination of the above uplink grants. In some embodiments, any of the uplink grants may be a configured uplink grant. In some embodiments, any of the uplink grants may be a dynamic uplink grant.

In some embodiments, the second indication may be carried by an RRC message. In some embodiments, the second indication may be carried by a MAC CE. In some embodiments where the second indication is carried by a MAC CE (for convenience, also referred to as a third MAC CE herein), the MAC CE may have a priority higher than a priority of data from any logical channels and lower than data from uplink common control channel (UL-CCCH). In other words, in case that the second indication is carried by a MAC CE, the MAC CE may have higher priority than “data from any logical channels, except data from UL-CCCH”.

Continue to refer to FIG. 4, the network device 120 (e.g., the target candidate cell) may transmit 460, to the terminal device 110, an indication (for convenience, also referred to as a first indication herein) of completion of the cell switch. In other words, the terminal device 110 may receive the first indication from the target candidate cell.

In some embodiments, the first indication may be a PDCCH transmission (for convenience, also referred to as a first PDCCH transmission herein) addressed to an identity of the terminal device 110, the PDCCH transmission comprising a DL assignment. For example, the first indication may be a PDCCH transmission addressed to C-RNTI of the terminal device 110, the PDCCH transmission comprising a DL assignment. In other words, the first indication may be DL assignment on the PDCCH for the MAC entity's C-RNTI.

In some embodiments, the first indication may be a PDCCH transmission (for convenience, also referred to as a second PDCCH transmission herein) addressed to an identity of the terminal device 110, the PDCCH transmission comprising a UL grant. For example, the first indication may be a PDCCH transmission addressed to C-RNTI of the terminal device 110, the PDCCH transmission comprising a UL grant. In other words, the first indication may be UL grant on the PDCCH for the MAC entity's C-RNTI.

In some embodiments, the first indication may be a PDCCH transmission (for convenience, also referred to as a third PDCCH transmission herein) addressed to an identity of the terminal device 110, the PDCCH transmission comprising a UL grant for a transmission to be performed (i.e., a new transmission). For example, the first indication may be a PDCCH transmission addressed to C-RNTI of the terminal device 110, the PDCCH transmission comprising a UL grant for a new transmission. In other words, the first indication may be a UL grant for a new transmission on the PDCCH for the MAC entity's C-RNTI.

In some embodiments, the first indication may be a PDCCH transmission (for convenience, also referred to as a fourth PDCCH transmission herein) addressed to an identity of the terminal device 110, the PDCCH transmission comprising a UL grant for a transmission (for convenience, also referred to as a first transmission herein) to be performed, the first transmission having a same hybrid automatic repeat request (HARQ) process as a transmission (for convenience, also referred to as a second transmission herein) that has been performed. For example, the first indication may be a PDCCH transmission addressed to C-RNTI of the terminal device 110, the PDCCH transmission comprising a UL grant for a new transmission of the same HARQ process of the initial transmission. In other words, the first indication may be UL grant for a new transmission of the same HARQ process of the initial transmission on the PDCCH for the MAC entity's C-RNTI.

In some embodiments, the first indication may be a MAC CE (for convenience, also referred to as a second MAC CE herein) on a physical downlink shared channel (PDSCH) indicated by a PDCCH transmission (for convenience, also referred to as a fifth transmission herein) addressed to an identity of the terminal device 110. For example, the first indication may be a MAC CE on PDSCH indicated by the PDCCH addressed to C-RNTI of the terminal device 110. In some embodiments, the second MAC CE may be an existing MAC CE. In some embodiments, the second MAC CE may be any of existing MAC CEs. In some embodiments, the second MAC CE may be different from the first MAC CE indicating the cell switch. In this case, there is no need to define a new MAC CE and extra signaling overhead may be saved. In some embodiments, the second MAC CE may be a newly defined MAC CE which has a fixed size of zero bits. In some embodiments, the second MAC CE may be a UE contention resolution identity MAC CE.

Continue to refer to FIG. 4, upon reception of the first indication, the terminal device 110 may stop 470 the timer. For example, a MAC layer of the terminal device 110 may send, to the RRC layer of the terminal device 110, an indication that the first indication of completion of the cell switch is received from the network device 120, and then the RRC layer may stop the timer. Alternatively, the MAC layer may stop the timer.

So far, a solution for RACH-less LTM is described. In this way, LTM may be considered as successful completed in case that an RA procedure is skipped.

### Example Implementation of Indication of PHR for LTM

For LTM, to further reduce service interruption time, a conventional MAC reset procedure may be avoided for some cases, e.g., intra-distributed unit (intra-DU) LTM. Instead, a terminal device may perform a partial MAC reset procedure (or maybe called as LTM specific MAC reset) during LTM. However, how to enable periodic PHR in case of partial MAC reset is still unclear.

In view of this, embodiments of the present disclosure provide a solution of PHR. The solution will be described below in connection with FIG. 5.

FIG. 5 illustrates a schematic diagram illustrating a process 500 of communication for PHR according to embodiments of the present disclosure. For the purpose of discussion, the process 500 will be described with reference to FIG. 1A. The process 500 may involve the terminal device 110 and the network device 120 as illustrated in FIG. 1A. In this example, the network device 120 provides a serving cell (e.g., the cell 121) for the terminal device 1105. The serving cell may be SPCell, PCell or PSCell of the terminal device 110.

As shown in FIG. 5, the network device 120 may transmit 510, to the terminal device 110, a MAC CE indicating a cell switch. That is, a LTM is triggered.

Upon reception of the MAC CE, the terminal device 110 may determine 520 that a partial MAC reset procedure is performed. In some embodiments, for partial MAC reset or LTM specific MAC reset, the terminal device 110 may skip “cancel, if any, triggered a buffer status reporting (BSR) procedure”. In other words, the terminal device 110 may maintain a BSR for partial reset. In some embodiments, the terminal device 110 may skip “initialize Bj for each logical channel to zero”. In other words, the terminal device 110 may maintain logical channel Bj. In some embodiments, the terminal device 110 may skip “flush the DL HARQ soft buffers”. In other words, the terminal device 110 may not flush the DL HARQ soft buffer. In some embodiments, the terminal device 110 may skip “set the new data indicators (NDIs) for all uplink HARQ processes to the value 0”. In other words, the terminal device 110 may not set NDI for UL HARQ processes to 0. In some embodiments, the terminal device 110 may skip “cancel, if any, triggered recommended bit rate query procedure”. In other words, the terminal device 110 may not cancel triggered recommended bit rate query procedure.

Continue to refer to FIG. 5, upon determination that the partial MAC reset procedure is performed, the terminal device 110 may enable 530 a periodic PHR.

In some embodiments for enabling of the periodic PHR, the terminal device 110 may start or restart a timer (e.g., phr-PeriodicTimer) for the periodic PHR. In some embodiments, if a MAC entity of the terminal device 110 has UL resources allocated for a new transmission, and if it is the first UL resource allocated for a new transmission since the last partial MAC reset, the terminal device 110 may start or restart the phr-PeriodicTimer.

In some alternative embodiments, the terminal device 110 may maintain the timer during the partial MAC reset procedure. In other words, the terminal device 110 may not stop the phr-PeriodicTimer during the partial MAC reset procedure.

In this way, periodic PHR reporting may be triggered in case of partial MAC reset during LTM.

### Example Implementation of SDU Discard for SRB

Conventionally, PDCP SDU discard for one SRB is performed only if an IE discardOnPDCP is set in a radio bearer configuration. However, for LTM, it may be not possible for a network to configure IE discardOnPDCP dynamically as the radio bearer configuration is optionally configured.

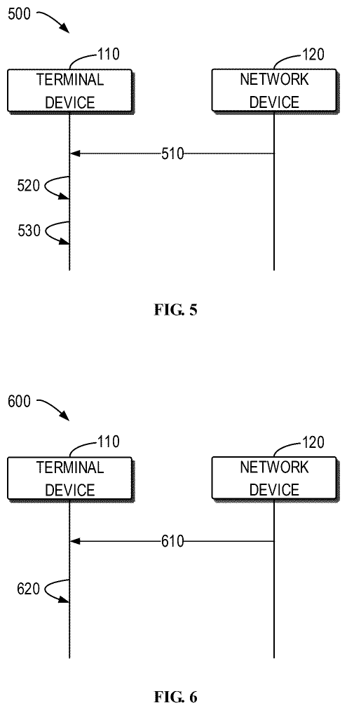

In view of this, embodiments of the present disclosure provide a solution of SDU discard for a SRB. The solution will be described below in connection with FIG. 6.

FIG. 6 illustrates a schematic diagram illustrating yet another process 600 of communication for SDU discard for a SRB. For the purpose of discussion, the process 600 will be described with reference to FIG. 1A. The process 600 may involve the terminal device 110 and the network device 120 as illustrated in FIG. 1A. In this example, the network device 120 provides a serving cell (e.g., the cell 121) for the terminal device 110. The serving cell may be SPCell, PCell or PSCell of the terminal device 110.

As shown in FIG. 6, the network device 120 transmits 610, to the terminal device 110, a MAC CE indicating a cell switch. That is, a LTM is triggered.

Upon reception of the MAC CE, the terminal device 110 performs 620 a SDU discard for a SRB by a PDCP entity of the terminal device 110. In other words, the terminal device 110 triggers the PDCP entity of SRB to perform SDU discard implicitly/without configuration or indication from the network implicitly or without configuration or indication from the network. In some embodiments, the SRB may be at least SRB1.

In some embodiments, upon reception of the MAC CE indicating the cell switch, a MAC entity of the terminal device 110 may indicate the cell switch to an RRC layer of the terminal device 110, and the RRC layer may indicate the lower layer (i.e. PDCP layer) to perform the SDU discard for the SRB.

In some alternative embodiments, upon reception of the MAC CE indicating the cell switch, the MAC layer of the terminal device 110 may indicate the upper layer (i.e. PDCP layer) to perform the SDU discard for the SRB.

In this way, when LTM is triggered or a MAC CE indicating a cell switch is received, a terminal device may trigger a PDCP entity to perform SDU discard for SRB(s) implicitly or without a configuration or indication from a network.

It is to be understood that the processes 200, 400, 500 and 600 may be carried out separately or in any suitable combination.

### Example Implementation of Methods

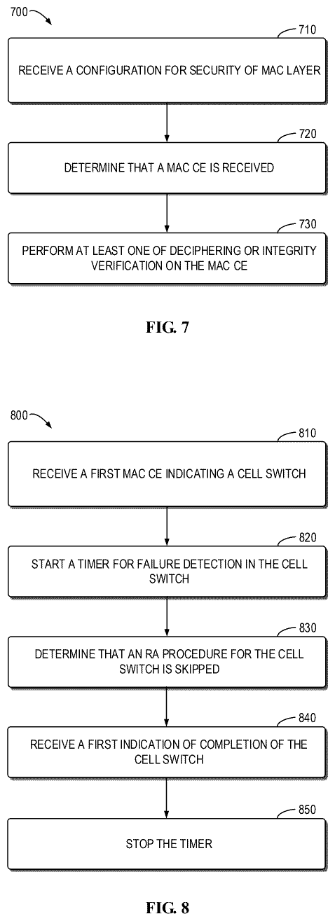

Accordingly, embodiments of the present disclosure provide methods of communication implemented at a terminal device. These methods will be described below with reference to FIGS. 7 to 10.

FIG. 7 illustrates an example method 700 of communication implemented at a terminal device in accordance with some embodiments of the present disclosure. For example, the method 700 may be performed at the terminal device 110 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the terminal device 110 receives, from the network device 120, a configuration for security of a MAC layer. In some embodiments, the configuration may comprise at least one of the following: a first configuration for ciphering, or a second configuration for integrity protection.

In some embodiments, the first configuration may comprise at least one of the following: an indication indicating whether the ciphering is enabled, or a ciphering algorithm. In some embodiments, the second configuration may comprise at least one of the following: an indication indicating whether the integrity protection is enabled, or an integrity protection algorithm.

At block 720, the terminal device 110 determines that a MAC CE is received. In some embodiments, the MAC CE may indicate LTM. In some embodiments, the MAC CE comprises at least one of a sequence number of the MAC CE or a MAC-I.

At block 730, the terminal device 110 performs, based on the configuration, at least one of deciphering or integrity verification on the MAC CE.

In some embodiments, the terminal device 110 may perform the deciphering on the MAC CE by determining a set of input parameters comprising at least one of a sequence number of the MAC CE, a logic channel identity of the MAC CE, a downlink direction, or a key for ciphering, and performing the deciphering on the MAC CE based on the set of input parameters.

In some embodiments, the terminal device 110 may perform the integrity verification on the MAC CE by determining a set of input parameters comprising at least one of a sequence number of the MAC CE, a LCID of the MAC CE, a downlink direction, or a key for integrity protection, and performing the integrity verification on the MAC CE based on the set of input parameters.

In some embodiments, if a further MAC CE is to be transmitted, the terminal device 110 may perform, based on the configuration, at least one of ciphering or integrity protection to generate the further MAC CE to be transmitted. In some embodiments, the further MAC CE may indicate completion of a cell switch for LTM. In some embodiments, the further MAC CE comprises at least one of a sequence number of the further MAC CE or a MAC-I.

In some embodiments, the terminal device 110 may perform the ciphering by determining a set of input parameters comprising at least one of a sequence number of the further MAC CE, a logic channel identity of the further MAC CE, an uplink direction, or a key for ciphering; and performing the ciphering based on the set of input parameters.

In some embodiments, the terminal device 110 may perform the integrity protection by: determining a set of input parameters comprising at least one of a sequence number of the further MAC CE, a logic channel identity of the further MAC CE, an uplink direction, or a key for integrity protection; and performing the integrity protection based on the set of input parameters.

With the method 700, MAC layer security may be ensured.

FIG. 8 illustrates another example method 800 of communication implemented at a terminal device in accordance with some embodiments of the present disclosure. For example, the method 800 may be performed at the terminal device 110 as shown in FIG. 1A. For the purpose of discussion, in the following, the method 800 will be described with reference to FIG. 1A. It is to be understood that the method 800 may include additional blocks not shown and/or may omit some blocks as shown, and the scope of the present disclosure is not limited in this regard.

At block 810, the terminal device 110 receives, from the network device 120, a first MAC CE indicating a cell switch to a target candidate cell.

At block 820, the terminal device 110 starts a timer for failure detection in the cell switch.

At block 830, the terminal device 110 determines that an RA procedure for the cell switch is skipped.

At block 840, the terminal device 110 receives, from the network device 120, a first indication of completion of the cell switch is received.

In some embodiments, if the terminal device 110 receives a first PDCCH transmission addressed to an identity of the terminal device 110 and the first PDCCH transmission comprises a DL assignment, the terminal device 110 may determine that the first indication is received.

In some embodiments, if the terminal device 110 receives a second PDCCH transmission addressed to the identity of the terminal device 110 and the second PDCCH transmission comprises a UL grant, the terminal device 110 may determine that the first indication is received.

In some embodiments, if the terminal device 110 receives a third PDCCH transmission addressed to the identity of the terminal device 110 and the third PDCCH transmission comprises a UL grant for a transmission to be performed, the terminal device 110 may determine that the first indication is received.

In some embodiments, if the terminal device 110 receives a fourth PDCCH transmission addressed to the identity of the terminal device 110, the fourth PDCCH transmission comprises a UL grant for a first transmission to be performed, and the first transmission has the same HARQ process as a second transmission that has been performed, the terminal device 110 may determine that the first indication is received.

In some embodiments, if the terminal device 110 receives a second MAC CE on a PDSCH indicated by a fifth PDCCH transmission addressed to the identity of the terminal device 110, the terminal device 110 may determine that the first indication is received. In some embodiments, the second MAC CE may be at least one of the following: a MAC CE different from the first MAC CE, a MAC CE having a fixed size of zero bits, or a UE contention resolution identity MAC CE.

At block 850, the terminal device 110 stops the timer. That is, upon reception of the first indication, the terminal device 110 stopes the timer.

In some embodiments, the terminal device 110 may transmit, to the network device 120, a further second indication of completion of the cell switch by at least one the following: a UL grant configured in the first MAC CE, a UL grant configured in a configuration associated with the target candidate cell, or a UL grant received from a PDCCH transmission of the target candidate cell addressed to an identity of the terminal device 110.

In some embodiments, the terminal device 110 may transmit the further second indication by a third MAC CE in a priority higher than a priority of data from a logic channel and lower than a priority of data from UL-CCCH.

In some embodiments, if a TA value is provided in the first MAC CE, the terminal device 110 may determine that the random access procedure for the cell switch is skipped. In some embodiments, if a timer for time alignment is running for a TAG to which the target candidate cell belongs, the terminal device 110 may determine that the RA procedure for the cell switch is skipped.

With the method 800, completion of RACH-less LTM may be indicated to a terminal device.

FIG. 9 illustrates still another example method 900 of communication implemented at a terminal device in accordance with some embodiments of the present disclosure. For example, the method 900 may be performed at the terminal device 110 as shown in FIG. 1A. For the purpose of discussion, in the following, the method 900 will be described with reference to FIG. 1A. It is to be understood that the method 900 may include additional blocks not shown and/or may omit some blocks as shown, and the scope of the present disclosure is not limited in this regard.

At block 910, the terminal device 110 receives, from the network device 120, a MAC CE indicating a cell switch.

At block 920, the terminal device 110 determines that a partial MAC reset procedure is performed.

At block 920, the terminal device 110 enables a periodic PHR.

In some embodiments, the terminal device 110 may enable the periodic PHR by at least one of the following: starting or restarting a timer for the periodic PHR; or maintaining the timer during the partial MAC reset procedure.

In this way, periodic PHR may be triggered in case of partial MAC reset during LTM.

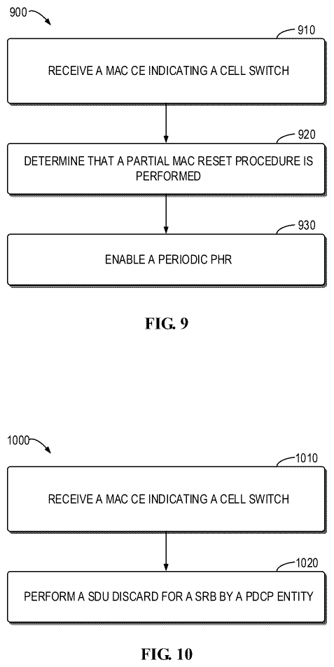

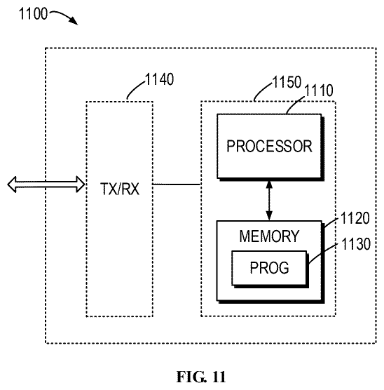

FIG. 10 illustrates yet another example method 1000 of communication implemented at a terminal device in accordance with some embodiments of the present disclosure. For example, the method 1000 may be performed at the terminal device 110 as shown in FIG. 1A. For the purpose of discussion, in the following, the method 1000 will be described with reference to FIG. 1A. It is to be understood that the method 1000 may include additional blocks not shown and/or may omit some blocks as shown, and the scope of the present disclosure is not limited in this regard.

At block 1010, the terminal device 110 receives, from the network device 120, a MAC CE indicating a cell switch.

At block 1020, the terminal device 110 performs a SDU discard for a SRB by a PDCP entity of the network device 120.

In some embodiments, if the MAC CE is received, the terminal device 110 may indicate the cell switch from a MAC entity of the terminal device to an RRC entity of the terminal device, and indicate the SDU discard for the SRB from the RRC entity to the PDCP entity.

In some embodiments, if the MAC CE is received, the terminal device 110 may indicate the SDU discard for the SRB from a MAC entity of the terminal device 110 to the PDCP entity.

In this way, PDCP SDU discard for a SRB may be triggered during LTM without an RRC configuration for the PDCP SDU discard.

It is to be understood that the operations of methods 700 to 1000 correspond to that described in connection with FIGS. 2 to 6, and thus other details are not repeated here for concise.

### Example Implementation of Devices and Apparatuses

FIG. 11 is a simplified block diagram of a device 1100 that is suitable for implementing embodiments of the present disclosure. The device 1100 can be considered as a further example implementation of the terminal device 110 or the network device 120 as shown in FIG. 1A. Accordingly, the device 1100 can be implemented at or as at least a part of the terminal device 110 or the network device 120.

As shown, the device 1100 includes a processor 1110, a memory 1120 coupled to the processor 1110, a suitable transmitter (TX) and receiver (RX) 1140 coupled to the processor 1110, and a communication interface coupled to the TX/RX 1140. The memory 1110 stores at least a part of a program 1130. The TX/RX 1140 is for bidirectional communications. The TX/RX 1140 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 1130 is assumed to include program instructions that, when executed by the associated processor 1110, enable the device 1100 to operate in accordance with the embodiments of the present disclosure, as discussed herein with reference to FIGS. 1A to 10. The embodiments herein may be implemented by computer software executable by the processor 1110 of the device 1100, or by hardware, or by a combination of software and hardware. The processor 1110 may be configured to implement various embodiments of the present disclosure. Furthermore, a combination of the processor 1110 and memory 1120 may form processing means 1150 adapted to implement various embodiments of the present disclosure.

The memory 1120 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 1120 is shown in the device 1100, there may be several physically distinct memory modules in the device 1100. The processor 1110 may be of any type suitable to the local technical network, and may include one or more of general purpose computers, special purpose computers, microprocessors, digital signal processors (DSPs) and processors based on multicore processor architecture, as non-limiting examples. The device 1100 may have multiple processors, such as an application specific integrated circuit chip that is slaved in time to a clock which synchronizes the main processor.

In some embodiments, a terminal device comprises a circuitry configured to: receive, from a network device, a configuration for security of a MAC layer; and in accordance with a determination that a MAC CE is to be received, perform, based on the configuration, at least one of deciphering or integrity verification on the MAC CE.

In some embodiments, a terminal device comprises a circuitry configured to: in accordance with a determination that a first MAC CE indicating a cell switch to a target candidate cell is received from a network device, start a timer for failure detection in the cell switch; determine that a random access procedure for the cell switch is skipped; and in accordance with a determination that a first indication of completion of the cell switch is received from the network device, stop the timer.

In some embodiments, a terminal device comprises a circuitry configured to: receive, from a network device, a MAC CE indicating a cell switch; and in accordance with a determination that a partial MAC reset procedure is performed, enable a periodic PHR.

In some embodiments, a terminal device comprises a circuitry configured to: receive, from a network device, a MAC CE indicating a cell switch; and perform a SDU discard for a SRB by a PDCP entity of the network device.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a terminal device comprises a processor configured to cause the terminal device to: receive, from a network device, a configuration for security of a medium access control (MAC) layer; and in accordance with a determination that a medium access control control element (MAC CE) is to be received, perform, based on the configuration, at least one of deciphering or integrity verification on the MAC CE.

In some embodiments, the configuration comprises at least one of the following: a first configuration for ciphering, or a second configuration for integrity protection.

In some embodiments, the first configuration comprises at least one of the following: an indication indicating whether the ciphering is enabled, or a ciphering algorithm.

In some embodiments, the second configuration comprises at least one of the following: an indication indicating whether the integrity protection is enabled, or an integrity protection algorithm.

In some embodiments, the MAC CE indicates layer 1 or layer 2 triggered mobility.

In some embodiments, the terminal device is caused to perform the deciphering on the MAC CE by: determining a set of input parameters comprising at least one of a sequence number of the MAC CE, a logic channel identity of the MAC CE, a downlink direction, or a key for ciphering; and performing the deciphering on the MAC CE based on the set of input parameters.

In some embodiments, the terminal device is caused to perform the integrity verification on the MAC CE by: determining a set of input parameters comprising at least one of a sequence number of the MAC CE, a logic channel identity of the MAC CE, a downlink direction, or a key for integrity protection; and performing the integrity verification on the MAC CE based on the set of input parameters.

In some embodiments, the terminal device is further caused to: in accordance with a determination that a further medium access control control element (MAC CE) is to be transmitted, perform, based on the configuration, at least one of ciphering or integrity protection to generate the further MAC CE to be transmitted.

In some embodiments, the terminal device is caused to perform the ciphering by: determining a set of input parameters comprising at least one of a sequence number of the further MAC CE, a logic channel identity of the further MAC CE, an uplink direction, or a key for ciphering; and performing the ciphering based on the set of input parameters.

In some embodiments, the terminal device is caused to perform the integrity protection by: determining a set of input parameters comprising at least one of a sequence number of the further MAC CE, a logic channel identity of the further MAC CE, an uplink direction, or a key for integrity protection; and performing the integrity protection based on the set of input parameters.

In some embodiments, the further MAC CE indicates completion of a cell switch for layer 1 or layer 2 triggered mobility.

In some embodiments, the further MAC CE comprises at least one of a sequence number of the further MAC CE or a message authentication code for integrity (MAC-I).

In some embodiments, the MAC CE comprises at least one of a sequence number of the MAC CE or a message authentication code for integrity (MAC-I).

In another solution, a terminal device comprises a processor configured to cause the terminal device to: in accordance with a determination that a first medium access control control element (MAC CE) indicating a cell switch to a target candidate cell is received from a network device, start a timer for failure detection in the cell switch; determine that a random access procedure for the cell switch is skipped; and in accordance with a determination that a first indication of completion of the cell switch is received from the network device, stop the timer.

In some embodiments, the terminal device is caused to receive the first indication by at least one of the following: receiving a first physical downlink control channel (PDCCH) transmission addressed to an identity of the terminal device, the first PDCCH transmission comprising a downlink assignment; receiving a second PDCCH transmission addressed to the identity of the terminal device, the second PDCCH transmission comprising an uplink grant; receiving a third PDCCH transmission addressed to the identity of the terminal device, the third PDCCH transmission comprising an uplink grant for a transmission to be performed; receiving a fourth PDCCH transmission addressed to the identity of the terminal device, the fourth PDCCH transmission comprising an uplink grant for a first transmission to be performed, the first transmission having a same hybrid automatic repeat request (HARQ) process as a second transmission that has been performed; or receiving a second MAC CE on a physical downlink shared channel (PDSCH) indicated by a fifth PDCCH transmission addressed to the identity of the terminal device.

In some embodiments, the second MAC CE is at least one of the following: a MAC CE different from the first MAC CE, a MAC CE having a fixed size of zero bits, or a user equipment (UE) contention resolution identity MAC CE.

In some embodiments, the terminal device is further caused to: transmit, to the network device, a second indication of completion of the cell switch by at least one the following: an uplink grant configured in the first MAC CE, an uplink grant configured in a configuration associated with the target candidate cell, or an uplink grant received from a physical downlink control channel (PDCCH) transmission of the target candidate cell addressed to an identity of the terminal device.

In some embodiments, the terminal device is caused to transmit the second indication by a third MAC CE in a priority higher than a priority of data from a logic channel and lower than a priority of data from uplink common control channel.

In some embodiments, the terminal device is caused to determine that the random access procedure for the cell switch is skipped by at least one of the following: determining that a timing advance value is provided in the first MAC CE; or determining that a timer for time alignment is running for a timing advance group to which the target candidate cell belongs.

In another solution, a terminal device comprises a processor configured to cause the terminal device to: receive, from a network device, a medium access control control element (MAC CE) indicating a cell switch; and in accordance with a determination that a partial medium access control (MAC) reset procedure is performed, enable a periodic power headroom report (PHR).

In some embodiments, the terminal device is caused to enable the periodic PHR by at least one of the following: starting or restarting a timer for the periodic PHR; or maintaining the timer during the partial MAC reset procedure.

In another solution, a terminal device comprises a processor configured to cause the terminal device to: receive, from a network device, a medium access control control element (MAC CE) indicating a cell switch; and perform a service data unit (SDU) discard for a signal radio bearer (SRB) by a packet data convergence protocol (PDCP) entity of the network device.

In some embodiments, the terminal device is caused to perform the SDU discard procedure by: in accordance with a determination that the MAC CE is received, indicating the cell switch from a medium access control (MAC) entity of the terminal device to a radio resource control (RRC) entity of the terminal device; and indicating the SDU discard for the SRB from the RRC entity to the PDCP entity.

In some embodiments, the terminal device is caused to perform the SDU discard procedure by: in accordance with a determination that the MAC CE is received, indicating the SDU discard for the SRB from a medium access control (MAC) entity of the terminal device to the PDCP entity.

In another solution, a method of communication comprises: receiving, at a terminal device and from a network device, a configuration for security of a medium access control (MAC) layer; and in accordance with a determination that a medium access control control element (MAC CE) is to be received, performing, based on the configuration, at least one of deciphering or integrity verification on the MAC CE.

In another solution, a method of communication comprises: in accordance with a determination that a first medium access control control element (MAC CE) indicating a cell switch to a target candidate cell is received from a network device, starting, at a terminal device, a timer for failure detection in the cell switch; determining that a random access procedure for the cell switch is skipped; and in accordance with a determination that a first indication of completion of the cell switch is received from the network device, stopping the timer.

In another solution, a method of communication comprises: receiving, at a terminal device and from a medium access control control element (MAC CE) indicating a cell switch; and in accordance with a determination that a partial medium access control (MAC) reset procedure is performed, enabling a periodic power headroom report (PHR).

In another solution, a method of communication comprises: receiving, at a terminal device and from a network device, a medium access control control element (MAC CE) indicating a cell switch; and performing a service data unit (SDU) discard for a signal radio bearer (SRB) by a packet data convergence protocol (PDCP) entity of the network device.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 10. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method for terminal device, comprising:
receiving, from a network device, medium access control control element (MAC CE) including layer 1 (L1)/layer 2 (L2) triggered mobility (LTM) Cell Switch Command on a serving cell,
indicating, to upper layers of the terminal device, procedure of the LTM Cell Switch is triggered,
starting a timer,
indicating, to the upper layers of the terminal device, the LTM cell switch is successfully completed and,
stopping the timer, and
wherein the LTM Cell Switch is random access channel (RACH)-less LTM Cell switch.

22. The method for terminal device of claim 21,
indicating, to the upper layers of the terminal device, the LTM cell switch is successfully completed if the terminal device receives downlink assignment on a first physical downlink control channel (PDCCH) for the MAC entity's cell-radio network temporary identity (C-RNTI) of the terminal device after physical uplink shared channel (PUSCH) transmission or uplink grant on physical downlink control channel (PDCCH) for the MAC entity's C-RNTI of the terminal device for a new transmission of same hybrid automatic repeat request (HARQ) process of the transmission after PUSCH transmission.

23. The method for terminal device of claim 22, wherein
the terminal device receives downlink assignment on the PDCCH for the MAC entity's C-RNTI of the terminal device after first PUSCH transmission, or
the terminal device receives uplink grant on the PDCCH for the MAC entity's C-RNTI of the terminal device for the new transmission of same HARQ process of the transmission after first PUSCH transmission.

24. A terminal device, comprising:
means for receiving, from a network device, medium access control control element (MAC CE) including LTM Cell Switch Command on a serving cell,
first means for indicating, to upper layers of the terminal device, procedure of the layer 1 (L1)/layer 2 (L2) triggered mobility (LTM) Cell Switch is triggered,
means for starting a timer,
second means for indicating, to the upper layers of the terminal device, the LTM cell switch is successfully completed and,
means for stopping the timer, and
wherein the LTM Cell Switch is random access channel (RACH)-less LTM Cell switch.

25. The terminal device of claim 24,
means for indicating, to the upper layers of the terminal device, the LTM cell switch is successfully completed if the terminal device receives downlink assignment on a first physical downlink control channel (PDCCH) for the MAC entity's cell-radio network temporary identity (C-RNTI) of the terminal device after physical uplink shared channel (PUSCH) transmission or uplink grant on physical downlink control channel (PDCCH) for the MAC entity's C-RNTI of the terminal device for a new transmission of same hybrid automatic repeat request (HARQ) process of the transmission after PUSCH transmission.

26. The method for terminal device of claim 25, wherein
the terminal device receives downlink assignment on the PDCCH for the MAC entity's C-RNTI of the terminal device after first PUSCH transmission, or
the terminal device receives uplink grant on the PDCCH for the MAC entity's C-RNTI of the terminal device for the new transmission of same HARQ process of the transmission after first PUSCH transmission.
